(19) United States
(12) Patent Application Publication
(10) Pub. No.: US 2026/0143348 A1
(43) Pub. Date: May 21, 2026

(54) Real-Time Multi-Device Authentication Though Wideband RF Waveform

(71) Applicants: Government of the United States as represented by the Secretary of the Air Force, Rome, NY (US); Northeastern University, Boston, MA (US)

(72) Inventors: Francesco Restuccia, Boston, MA (US); Milin Zhang, Somerville, MA (US); Ildi Alla, Villeneuve-d'Ascq (FR); Valeria Loscri, Villeneuve-d'Ascq (FR); Jonathan Ashdown, Greenwich, NY (US)

(21) Appl. No.: 19/394,604

(22) Filed: Nov. 19, 2025

Related U.S. Application Data
(60) Provisional application No. 63/723,561, filed on Nov. 21, 2024.

(51) Int. Cl. H04W 12/79; H04L 41/16; H04W 12/06

(52) U.S. Cl. CPC H04W 12/79; H04L 41/16; H04W 12/06

(57) ABSTRACT

A method of authenticating a received signal comprises receiving signals within a spectrum of bandwidth B, converting the signals into a frequency domain representation of bandwidth B, and segmenting the frequency domain representation of bandwidth B into spectrum segments each of training bandwidth W. For each spectrum segment, the method further comprises applying the spectrum segment to a neural network, and receiving, from the neural network, a radio frequency identification map comprising two or more classification vectors. The method further comprises determining a total variation across the two or more classification vectors and identifying the received signal as authenticated when the total variation is less than a threshold value. The method may further comprise training the neural network using a training dataset of wideband training samples. The method may further comprise generating each of the wideband training samples by stitching together two or more stored signals.

### RELATED APPLICATIONS

This application claims the benefit of U.S. Provisional Application No. 63/723,561, filed on Nov. 21, 2024. The entire teachings of the above application(s) are incorporated herein by reference.

### GOVERNMENT SUPPORT

This invention was made with government support under Grant Nos. ECCS-2329013 and ECCS-2229472 were awarded by the National Science Foundation. The government has certain rights in the invention.

### BACKGROUND

The sheer growth of the Internet of Things (IoT) is quickly saturating unlicensed spectrum bands. As unlicensed bands become saturated, spectrum sharing will become one of the very few options to sustain the IoT growth in the years to come. The key issue is that today, IoT operators that want to share spectrum with licensed users (incumbents) must contact database systems located in the cloud, which determine if the spectrum is available based on geographical coordinates. This centralized manual approach lacks scalability and does not allow for fine-grained real-time spectrum management.

Conversely, a scalable and effective solution would be to let IoT devices opportunistically discover which spectrum sub-bands are currently available among ongoing licensed transmissions, provided they do not cause harmful interference to incumbents. Such dynamic spectrum access systems create fundamentally new security challenges where incumbents must be protected by secondary users not abiding by spectrum rules. To prevent such issues, spectrum must be continuously monitored to make sure only authorized devices are using the spectrum.

Traditional wireless authentication systems such as WPA for Wi-Fi or 5G-AKA for cellular networks are based on cryptography or password-based authentication. As such, they primarily operate at the network or application layers, thus failing to meet the real-time requirements of spectrum sharing. In addition, these methods are proven insufficient against various attacks, such as spoofing, replay, and impersonation attacks.

Radio fingerprinting has recently emerged as a viable approach for spectrum-level authentication. Specifically, radio fingerprinting leverages hardware imperfections present in every radio circuitry to form a unique and unforgeable fingerprint that can be used to authenticate devices. By exploiting these characteristics, radio fingerprinting offers a security solution that is resistant to attacks such as MAC address spoofing and identity cloning. Existing radio fingerprinting systems, however, have a series of core limitations that makes them unable to perform real-time spectrum-level authentication.

### SUMMARY

The described embodiments are directed to a spectrum-level authentication system that implements radio fingerprinting of multiple devices across multiple frequency bands. Existing radio fingerprinting systems have limitations that make such systems unable to perform real-time spectrum-level authentication. FIGS. 1A and 1B illustrate a fundamental difference between prior work (FIG. 1A) and the approach of the described embodiments (FIG. 1B). Current approaches only classify one signal within a given channel of interest. Conversely, multiple signals are usually overlapping in adjacent bands making the classification problem harder. Second, conventional methods assume prior knowledge of operating frequency of transmitters and only classify signals in that specific frequency band. Some signals, however, may be partially observed by the receiver, e.g., because they are partially outside the operating bandwidth.

An example embodiment comprises a spectrum-level authentication system referred to herein as Multi-band Multi-device Radio Fingerprinting (M2RF), where multiple devices are located and identified in the same spectrum band using spectrum segmentation. FIG. 1B shows, at a very high level, the main objective of M2RF. The approach of the described embodiments directly operates on unprocessed in-phase/quadrature (I/Q) inputs coming from the radio receiver front-end, thereby eliminating pre-processing steps. The spectrum segmentation model of the described embodiments, based on a Deep Neural Network (DNN), is specifically designed to handle dynamic signal and channel bandwidths through the integration of a non-local block, which captures long-range dependencies across frequency and distinguishes subtle differences in RF signals via a self-attention mechanism. In addition, the described embodiments incorporate a combined loss function that integrates both local-level and region-level features, further enhancing its ability to learn intricate signal features while maintaining consistent accuracy.

An aggregation block supports wideband classification by combining predictions across overlapping frequency bands, allowing the DNN model to span and accurately identify signals across different frequency segments. The features of the described embodiments are effective on different open problems. From one side, it is possible to detect, in real-time, the intrusion tentative from malicious sides by accurately distinguishing between legitimate and illicit devices. Another feature is the capacity to locate the activity of malicious devices in the spectrum, posing the fundamentals of advanced anti-jamming solutions, targeting the malicious operating frequencies with high precision.

In one aspect, the invention may be a method of authenticating a received signal, comprising receiving signals within a spectrum of bandwidth B, converting the signals into a frequency domain representation of bandwidth B, and segmenting the frequency domain representation of bandwidth B into spectrum segments each of training bandwidth W. For each spectrum segment, the method may further comprise applying the spectrum segment to a neural network, and receiving, from the neural network, a radio frequency identification map comprising two or more classification vectors. The method may further comprise determining a total variation across the two or more classification vectors, and identifying the received signal as authenticated when the total variation is less than a threshold value.

The method may further comprise training the neural network using a training dataset of wideband training samples. The method may further comprise generating each of the wideband training samples by stitching together two or more stored signals. The method may further comprise generating each of the two or more stored signals by (i) generating, in a controlled environment, a radio signal having a center frequency and a bandwidth, (ii) segmenting the radio signal into smaller portions using a windowing function, (iii) filtering each of the smaller portions using a band-pass filter, (iv) converting each of the smaller portions into the frequency domain, (v) pruning frequencies outside of a frequency band of interest, and (vi) storing each of the segmented, filtered, pruned, frequency domain signal representations in a signal repository.

The method may further comprise estimating a noise floor across the training dataset of wideband training samples by recording minimum values of smoothed signal power in the frequency domain. The method may further comprise generating each of the wideband training samples as (i) non-overlapping in-band signals, (ii) one or more in-band signals and one or more partially out-of-band signals, and/or (iii) overlapping in-band signals. The neural network may have a U-Net architecture. The U-Net architecture neural network may have a non-local block incorporated into a last layer of the neural network.

The method may further comprise aggregating predictions from individual spectrum segments to form the radio frequency identification map. Receiving the signals may further comprise receiving in-phase and quadrature (I/Q) data from a radio receiver.

In another aspect, the invention may be a system for authenticating a received signal, comprising a radio frequency receiver that (i) receives signals within a spectrum of bandwidth B, (ii) converts the signals into a frequency domain of bandwidth B, and (iii) segments the frequency domain of bandwidth B into spectrum segments each of training bandwidth W. The system may further comprise a processor and a memory with computer code instructions stored thereon, the memory operatively coupled to the processor such that, when executed by the processor, the computer code instructions cause the system to: implement a neural network that produces, for each spectrum segment, a radio frequency identification map that comprises two or more classification vectors, determine a total variation across the two or more classification vectors, and identify the received signal as authenticated when the total variation is less than a threshold value.

The neural network may be trained using a training dataset of wideband training samples. Each of the wideband training samples may be generated by stitching together two or more stored signals. The computer code instructions may further cause the system to (i) generate, in a controlled environment, a radio signal having a center frequency and a bandwidth, (ii) segment the radio signal into smaller portions using a windowing function, (iii) filter each of the smaller portions using a band-pass filter, (iv) convert each of the smaller portions into the frequency domain, (v) prune frequencies outside of a frequency band of interest, and (vi) store each of the segmented, filtered, pruned, frequency domain signal representations in a repository.

The neural network may have a U-Net architecture. The U-Net architecture neural network may have a non-local block incorporated into a last layer of the neural network. Predictions from individual spectrum segments may be aggregated to form the radio frequency identification map.

In yet another aspect, the invention may be a method of authenticating a received signal, comprising receiving radio frequency signals, and converting the radio frequency signals into a frequency domain representation and segmenting the frequency domain representation into spectrum segments. For each spectrum segment, the method may further comprise applying the spectrum segment to a neural network, receiving, from the neural network, a radio frequency identification map comprising two or more classification vectors, determining a total variation across the two or more classification vectors, and identifying the received signal as authenticated when the total variation is less than a threshold value.

The method may further comprise training the neural network using a training dataset of wideband training samples. The method may further comprise generating each of the wideband training samples by stitching together two or more stored signals.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A shows prior art authentication operation.

FIG. 1B shows authentication operation according to an embodiment of the invention.

FIG. 2 shows a threat model with an authorized device, an authenticator, and an attacker.

FIG. 3 shows an overview of the main components of an example embodiment of the invention.

FIG. 4 shows an example of scenario generation with 50 MHz observable bandwidth and 20 MHz wide signals.

FIG. 5 shows the five encoding and five decoding blocks of the U-Net based architecture of an example embodiment.

FIG. 6 shows the adaptive pipeline that processes signals exceeding the standard training bandwidth.

FIG. 7 shows signal identification maps from the neural network for a legitimate user as compared to a malicious user.

FIG. 8 shows components of an experimental setup for an example embodiment.

FIG. 9 shows the F1 score for three different scenarios, given three different input sizes.

FIG. 10 shows performance scores for different scenarios with a wired experimental setup.

FIG. 11 shows predicted card ID versus actual card ID for scenario 1.

FIG. 12 shows predicted card ID versus actual card ID for scenario 2.

FIG. 13 shows predicted card ID versus actual card ID for scenario 3.

FIG. 14 shows detected signals of four devices within a 100 MHz bandwidth, each device occupying 20 MHz.

FIG. 15 shows detected signals of two devices within a 100 MHz bandwidth, each device occupying 40 MHz.

FIG. 16 shows mean interference time (MIT) and mean energy consumption (MEC) with respect to input size for a CPU and a GPU.

FIG. 17 shows predicted card ID versus actual card ID for wired scenario 1.

FIG. 18 shows predicted card ID versus actual card ID for wired scenario 2.

FIG. 19 shows predicted card ID versus actual card ID for wired scenario 3.

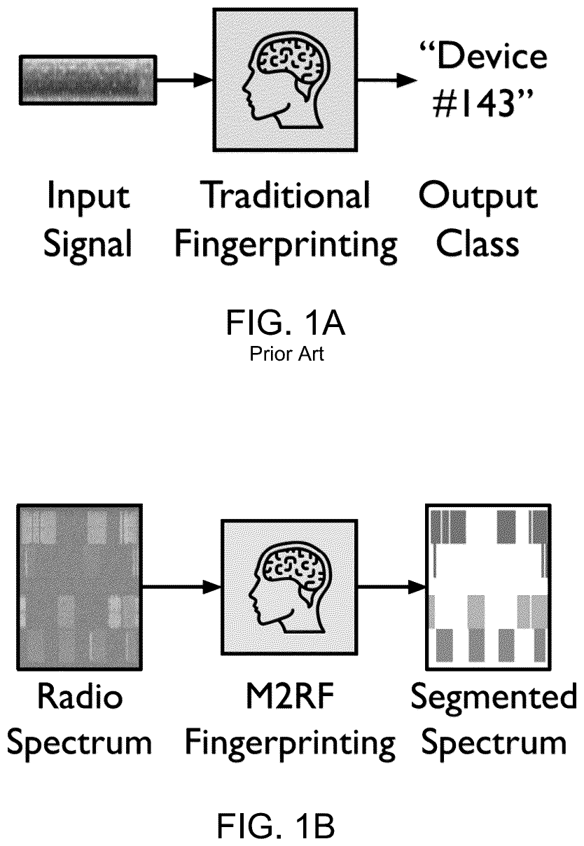

### DETAILED DESCRIPTION

A description of example embodiments follows.

The embodiments described herein are directed to a spectrum-level authentication system that implements radio fingerprinting of multiple devices across multiple frequency bands.

The described embodiments encompass a real-time, technology-independent radio fingerprinting approach referred to herein as Multi-band Multi-device Radio Fingerprinting (M2RF) that can simultaneously fingerprint multiple devices coexisting in the shared spectrum. M2RF includes (i) a scalable dataset generation pipeline that can represent real-world spectrum conditions such as overlapping signals, and (ii) an energy-efficient deep neural network (DNN) optimized for resource-constrained devices, which facilitates a real-time end-to-end system for radio fingerprinting. The described embodiments comprise an anomaly detection mechanism to detect adversarial/malicious users in spectrum sharing scenarios. Total Variation (TV) analysis is leveraged to identify attacks by detecting irregularities in the DNN output. Specifically, TV analysis exploits the fact that the DNN produces noisy and randomized outputs when fed with an unseen signal, so that real-time detection is realized without prior knowledge of the specific attacks strategy.

Performance of an example embodiment was evaluated using a comprehensive 82 GB dataset of over-the-air (OTA) data from 15 identical Wi-Fi cards, which represents the worst case for radio fingerprinting as identical devices may have closer fingerprints. In addition, data was collected through a wired connection so that data unaffected by the wireless channel is available. To simulate real-world threats, both white-box and black-box attack scenarios are considered. For white-box attacks, data was collected from additional identical Wi-Fi devices having full knowledge of the authentication approach. For black-box attacks, data was collected from different Wi-Fi cards as well as from other wireless technologies (e.g., Bluetooth Low Energy (BLE), Long Term Evolution (LTE), Zigbee) to evaluate the example embodiment performance in congested multi-technology environments.

Experimental results show that the example embodiment achieves F1-score of 94.99% and Intersection over Union (IoU) of 90.54% with over-the-air non-overlapping signals. In the challenging scenario of overlapping signals, the example embodiment achieves F1-score of 77.06% and IoU of 63.39% without retraining and/or fine-tuning. Moreover, the example embodiment detects adversarial users with an accuracy of 92.44%, demonstrating resilience against both white-box and black-box attacks. When other technologies are present, the example embodiment achieves an overall accuracy of 81.52%.

### Preliminaries on Radio Fingerprinting

Radio fingerprinting relies on the inherent imperfections in hardware components such as oscillators, amplifiers, and antennas, which introduce tiny distortions into transmitted signals. Together, these imperfections create device-specific “fingerprints.” As such, radio fingerprinting offers a reliable way to authenticate transmitters even in the case of cloning/spoofing. In addition, unlike higher-layer security methods, radio fingerprinting operates at the physical layer, resulting in less latency.

Technical Challenges. Current radio fingerprinting approaches are designed to work in controlled environments and with minimal interference. Moreover, existing approaches involve band filtering and pre-processing to remove interference and channel effect before classification, which assumes prior knowledge of the bandwidth and operating frequency of transmitted signal. This does not apply to spectrum sharing systems, as devices can dynamically select their operating frequency based on spectrum availability. In short, M2RF addresses the following challenges:

Environment. Radio fingerprinting needs to operate in spectrum environments where multiple devices change their carrier frequency dynamically, and thus, the received signal may partially appear in the observed frequency domain and may overlap with other signals.

Functionality. Radio fingerprinting needs to jointly detect multiple signals in different frequency bins rather than classifying a single signal and being able to identify unauthorized devices that are not part of the known device population.

### Threat Model and Scope

Outlined are the potential threats, the capabilities and knowledge levels of an adversary, as well as how the example embodiment is structured to defend against these specific challenges.

Attacks Capabilities. The example embodiment is robust for three types of attacks: Spoofing Attacks, Replay Attacks, and Device Impersonation attacks.

The spoofing scenario involves an attacker (referred to herein as Eve) emulating the credentials of an authorized device (referred to herein as Alice) by cloning identifiers such as MAC addresses. Here, Eve's goal is to deceive the authentication system by masquerading as a legitimate device without replicating the hardware-specific imperfections that are unique to Alice.

For replay attacks, Eve intercepts transmissions from Alice and replays them, aiming to deceive the system and gain unauthorized access without the need to directly imitate Alice's radio signal characteristics. Replay attacks exploit captured communication sessions, assuming they will appear legitimate upon retransmission.

For device impersonation attacks, Eve manipulates signal characteristics to closely imitate Alice's fingerprint. By using similar devices or attempting software-based modifications, Eve aims to create a sufficiently close match to bypass RF fingerprint detection. This approach assumes that Eve has knowledge of Alice's signal characteristics and attempts to mimic them. Still, the unique hardware imperfections inherent to Alice's device cannot be acquired by Eve. The threat model is centered around Bob, the authenticator, who uses radio fingerprinting to characterize hardware-induced distortions.

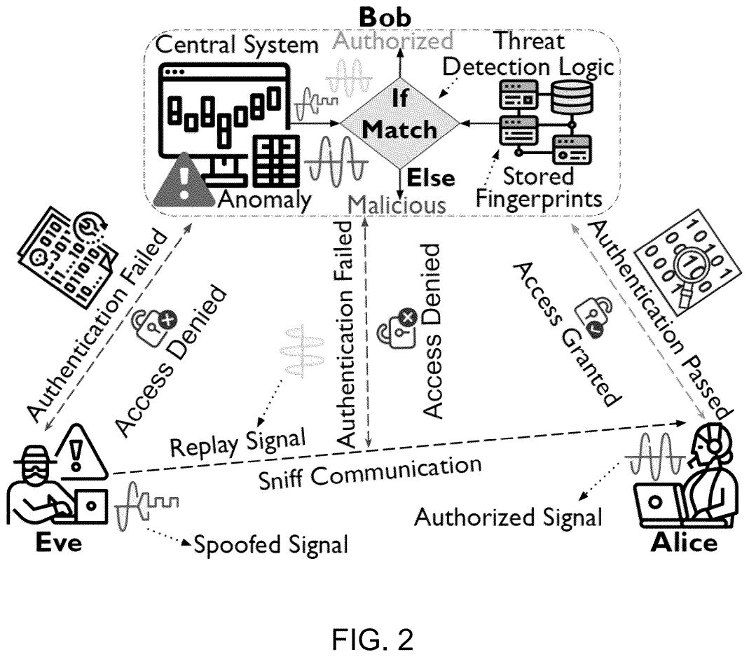

FIG. 2 provides an overview of the above-described interactions between Alice, Eve, and Bob. The inherent hardware variations embedded in Alice's signal make it exceedingly difficult for Eve to generate a convincing imitation, even with knowledge of Alice's credentials.

Adversary's Knowledge. There are two distinct knowledge models for Eve, referred to herein as Black-box Attacks and White-box Attacks. In a Black-box Attack, Eve lacks specific knowledge about Alice's hardware imperfections and Bob's detection mechanisms. Eve may attempt standard spoofing or basic replay methods without insight into the physical layer defense, relying on generic attack methods.

In a White-box Attack, Eve possesses detailed knowledge of Alice's hardware features, the radio fingerprinting algorithm and how the authentication is performed by Bob. This knowledge allows Eve to adopt more sophisticated techniques to approximate Alice's signal characteristics. Despite this, Eve is still constrained by the inability to precisely replicate the hardware-induced distortions that uniquely identify Alice's device.

Defense Mechanisms. Three critical elements that ensure robust authentication are Real-time Monitoring, Radio Fingerprint Consistency Check, and Multi-Bandwidth Authentication. For Real-time Monitoring, Bob continuously assesses the radio spectrum to detect unauthorized access by monitoring variations in the signal pattern using metrics such as Total Variation (TV).

For Radio Fingerprint Consistency Check, Bob assesses radio fingerprint consistency across multiple frequency bands. Malicious signals manipulated through adversarial attacks show increased TV and are flagged as anomalous compared to stable legitimate signals.

For Multi-Bandwidth Authentication. Bob's architecture adapts to different frequency bands and bandwidths to keep robustness across wireless environments, independently to the specific communication technology.

### Framework of Example Embodiment (M2RF)

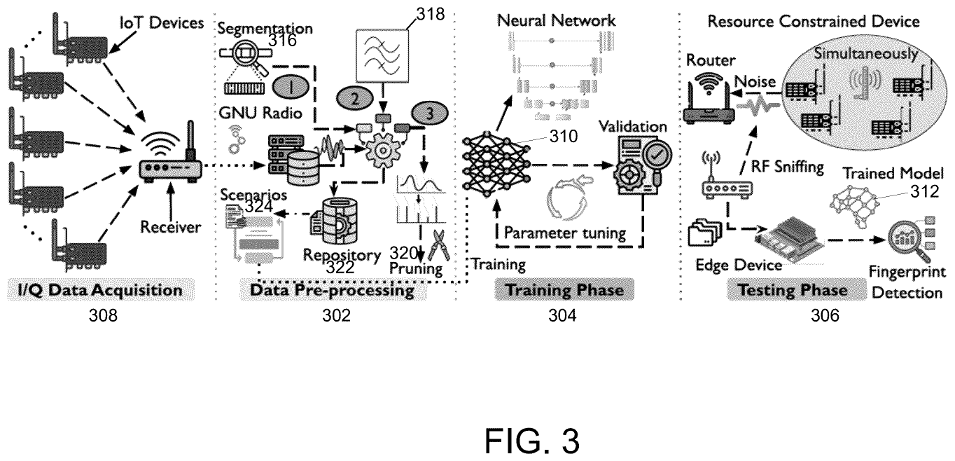

FIG. 3 provides an overview of the main components of an example embodiment of the invention (M2RF), which are pre-processing 302, training 304, and testing 306. The process begins with I/Q data acquisition 308, followed by pre-processing 302, where the data is filtered, segmented, and transformed into the frequency domain for storage. These signals are then used to generate a dataset to train the DNN 310, which undergoes validation and fine-tuning. Finally, the trained DNN 312 is tested in operational environments, with adversarial detection logic also incorporated. We explain each component of M2RF in the following subsections.

Data Pre-processing 302. The effectiveness of radio fingerprinting relies heavily on the quality of the training data. For this reason, effective datasets are generated through a controlled, systematic pre-processing pipeline. As described in detail below, the generation of effective datasets start with the creation of a comprehensive signal repository, followed by the generation of diverse training samples that simulate a range of realistic conditions.

Signal Repository. A curated collection of individual high-quality radio signals, captured under controlled conditions is built. These signals are recorded sequentially, ensuring that only one transmission occurs at a time, with known center frequencies f_{c} and bandwidths B. This controlled environment ensures that each signal is free from external interference or overlapping transmissions, capturing the characteristics necessary for subsequent processing and accurate radio fingerprinting. Once collected, each radio signal s(t) undergoes the following procedure.

Segmentation. The continuous time-domain signal s(t) is segmented 316 into smaller portions to isolate the relevant transmission. Let T be the duration of the relevant signal. The segmentation process can be represented as:

$${s}_{s e g} ( t ) = s ( t ) \cdot w ( t ) \qquad ( 1 )$$

where w(t) is a windowing function defined as:

$$w ( t ) = \{ \begin{matrix}1 & for 0 \leq t \leq T \\ 0 & otherwise\end{matrix} . \qquad ( 2 )$$

The segmented signal s_{seg}(t) contains only the transmission period, removing silence or non-relevant data.

Band-Pass Filtering. The segmented signal s_{seg}(t) is passed through a band-pass filter 318 to isolate the signal of interest. The band-pass filter 318 is designed with a center frequency f_{c} and bandwidth B, and its frequency response H(f) is defined as:

$$H ( f ) = \{ \begin{matrix}1 & for {f}_{c} - \frac{B}{2} \leq f \leq {f}_{c} + \frac{B}{2} \\ 0 & otherwise\end{matrix} . \qquad ( 3 )$$

The filtered signal s_{bp}(t) is then:

$${s}_{bp} ( t ) = {ℱ}^{- 1} \{ {S}_{eg} ( f ) \cdot H ( f ) \} , \qquad ( 4 )$$

where S_{seg}(f)= [symbol] {s_{seg}(f)} is the Fourier transform of the segmented signal.

Fast Fourier Transform (FFT). The filtered signal s_{bp}(t) is then converted to the frequency domain using the FFT, resulting in S_{fft}(f):

$${S}_{fft} ( f ) = FFT \{ {s}_{bp} ( t ) \} \qquad ( 5 )$$

Pruning of Unwanted Frequency Components. To ensure that only the relevant frequency components are retained, any frequencies outside the band of interest are pruned 320. The pruned signal S_{pruned}(f) is defined as:

$${S}_{pruned} ( f ) = \{ \begin{matrix}{S}_{fft} ( f ) & for {f}_{c} - \frac{B}{2} \leq f \leq {f}_{c} + \frac{B}{2} \\ 0 & otherwise\end{matrix} . \qquad ( 6 )$$

Storage in Signals Repository. The pruned I/Q samples S_{pruned}(f) are then stored in the signals repository 322. This repository forms a versatile and robust dataset, ready for use in further analysis, simulation, and model training, ensuring the precision needed for accurate radio fingerprinting. The entire pre-processing pipeline can thus be summarized as the transformation:

$$s ( t ) \to {s}_{seg} ( t ) \to {s}_{bp} ( t ) \to {S}_{fft} ( f ) \to {S}_{pruned} ( f ) \to {sig}_{repo} .$$

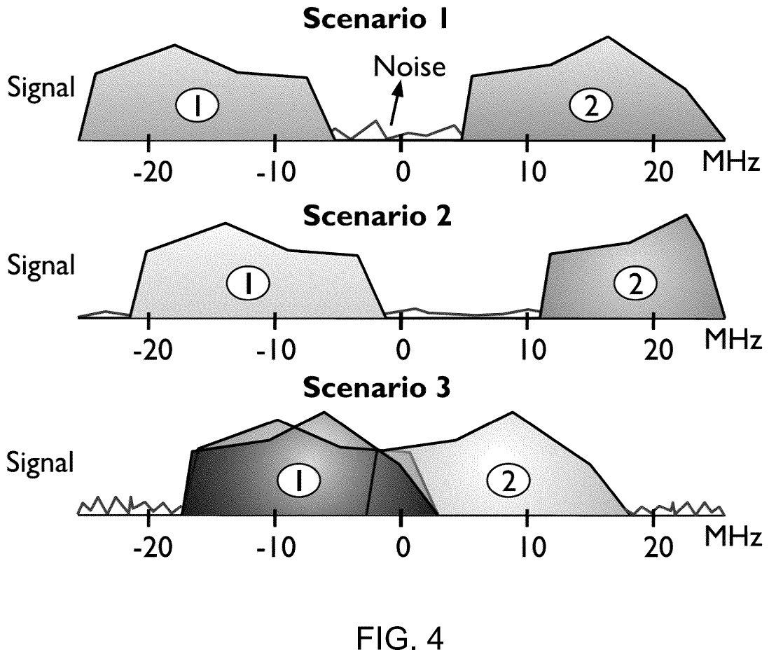

Simulation of Scenarios. Scenario generation 324 is a crucial step that simulates a wide variety of real-world environments. By integrating multiple signals into a “stitched” wideband signal, this approach reduces the need for extensive real-world data collection. By using such stitching procedure made with individual signal widths, the pipeline dynamically generates numerous training samples that can work with different signal bandwidths. FIG. 4 shows an example of scenario generation with 50 MHz observable bandwidth and 20 MHz wide signals. The scenarios are generated with a procedure described in Procedure 1, which assembles signals into a complete training sample via ‘spectrum stitching.’

Procedure 1 Sample generation using spectrum stitching

| Require: sigᵣₑₚₒ, buf, B, signal_{bw}, n_{iq}, max_{signals}, prob_{empty}, | |
|---|---|
| | prob_{centered} |
| 1: | Decide if the bandwidth is empty based on prob_{empty} |
| 2: | if bandwidth is not empty then |
| 3: | Select randomly n_{signals} from 1 to max_{signals} |
| 4: | Randomly choose transmitters from sigᵣₑₚₒ |
| 5: | for each card signal do |
| 6: | Extract corresponding signal from sigᵣₑₚₒ |
| 7: | Determine center frequency f_{center} |
| 8: | if Scenario 1 then |
| 9: | Sequential placement in buffer |
| 10: | else if Scenario 2 then |
| 11: | Random placement without overlap |
| 12: | else if Scenario 3 then |
| 13: | Allow overlaps |
| 14: | end if |
| 15: | Update labelₘₐₜᵣᵢₓ and buf |
| 16: | end for |
| 17: | end if |
| 18: | Add background noise from sigᵣₑₚₒ |
| 19: | Stitch signals and noise to finalize inputₛₐₘₚ |
| 20: | return inputₛₐₘₚ and labelₘₐₜᵣᵢₓ |

Procedure 1 first determines if the observable bandwidth will be empty, based on the probability prob_{empty}. If not empty, it selects a number n_{signals} between 1 and max signals of signals from the repository sigᵣₑₚₒ. Placement within the bandwidth is guided by a center frequency f_{center}, chosen randomly based on the parameter prob_{centered}, which controls whether signals are centered or distributed. The final procedure step adds background noise sourced from the signals repository to the stitched signal to simulate realistic conditions. The resulting sample is then stored with its label matrix. The resolution of scenarios, defined by the frequency sub-band size into which the observable bandwidth is divided, is given by:

$$resolution ( R ) = \frac{B}{{n}_{i q}} .$$

This resolution sets the granularity for analyzing and classifying the signal spectrum. The label matrix, structured as C×n_{iq} (where C is the number of classes), enables fine-grained classification across the bandwidth.

Spectrum Fingerprinting. This approach is based on semantic segmentation that can simultaneously detect and classify multiple devices in wide spectrum bands. Outlined below are the multi-label semantic segmentation methodology, the structure of the DNN model, its adaptability to varying input sizes, generalization strategies, and the scalable processing techniques we implemented. Additionally, details are provided of the various loss functions and the specific adversarial technique used in this approach.

Multi-Label Signal Segmentation. Unlike traditional spectrum sensing methods that typically detect and classify signals in isolation, the approach of the described embodiments utilizes semantic segmentation. Specifically, the captured waveform is transformed into the frequency domain and divided it into multiple sub-channels. A Deep Learning (DL)-based semantic segmentation algorithm is then applied to detect signals across the bandwidth. Similar to image-based semantic segmentation, which labels each pixel based on its semantic information in image domain, the signal segmentation approach of the described embodiments labels each sub-channel based on waveform-level features. This enables the simultaneous detection and classification of multiple overlapping signals within the bandwidth.

One significant difference between the image segmentation and signal segmentation is the multi-label nature of the radio environment. In an image, the object in the behind will be blocked by the object in the front by its non-transparent nature. In contrast, different signals can coexist within the same frequency band without occluding each other in the radio environment. As a result, each frequency bin can be assigned to multiple classes simultaneously. Therefore, the semantic segmentation algorithm is extended to output a binary segmentation map for each class, where each map indicates the presence or absence of the corresponding class within the given frequency bin. The final segmentation output is a matrix where each row corresponds to a class and each column corresponds to a frequency bin.

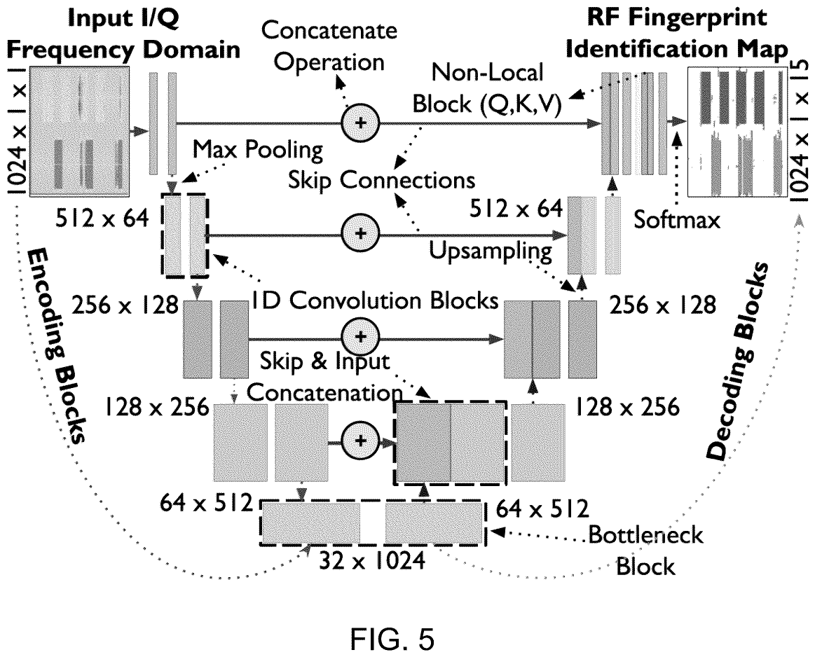

DNN Model Architecture. The example embodiment backbone is inspired from the U-Net architecture, which was initially proposed for biomedical image segmentation. We adapted this architecture for radio fingerprinting by replacing the 2D convolutional layers with 1D convolutions to process I/Q samples effectively. As illustrated in FIG. 5, the U-Net based architecture comprises five encoding and five decoding blocks. The encoding path systematically down-samples the input data, capturing features at varying levels of abstraction through 1D convolutional layers, batch normalization, and rectified linear unit (ReLU) activations. Max pooling layers are employed within each encoding block to reduce the spatial dimensions.

The decoding path mirrors the encoding process, progressively reconstructing the data to its original size using up-sampling layers. Skip connections between corresponding encoding and decoding blocks ensure that spatial information, crucial for accurately identifying device-specific characteristics in radio signals, is preserved throughout the DNN. The final layer applies a 1×1 convolution to produce a multi-channel output, resulting in a C×n_{iq} matrix, where each channel corresponds to a different class in the multilabel segmentation task.

Integration of Non-local Block. One issue of U-Net is that its architecture fully comprises convolutional neural networks (CNNs). However, conventional CNNs often struggle with capturing long-range dependencies, especially in radio applications where signals are widespread to large bandwidth in the spectrum. As such, conventional U-Net may misclassify a portion of sub-channels as the output is based on a group of neighboring features in sub-channels without considering the dependencies across frequency. As such, a non-local block is incorporated into the last layer to enhance the performance. The non-local block addresses this by introducing a self-attention mechanism that allows the network to consider the global context of the feature maps. The self-attention is defined as:

$$Attention ( Q , K , V ) = softmax ( \frac{Q {K}^{T}}{\sqrt{d}} ) V , \qquad ( 7 )$$

where Q, K, and V represent the Queries, Keys, and Values, respectively, derived from the feature maps using 1×1 convolutions. Here, dis the embedding dimension. This operation computes a weighted sum of the entire feature map, effectively enabling the model to capture long-range dependencies. The integration of the non-local block ensures that the DNN can accurately classify RF signals, even in scenarios where signals overlap or interfere with each other. During training, the noise floor is estimated across the training dataset by recording the minimum values of the smoothed signal power in the frequency domain. This noise estimate is then used to normalize the input signals during inference, ensuring that the model can generalize to different noise levels encountered in real-world deployments. The effectiveness of this approach is enhanced by the scenario generation process described herein, which introduces a variety of signal placements, overlaps, and noise conditions into the training data. This diversity ensures that the model can handle a wide range of RF conditions without overfitting to specific scenarios.

Adaptive Signal Bandwidth and Channel Bandwidth Processing. In spectrum sharing scenarios, transmitted signals will use dynamic bandwidth sizes according to the currently available spectrum. This can be different from the DNN training bandwidth W. Additionally, the observable bandwidth B of the receiver may change. As such, the example embodiment ensures consistent performance by leveraging hardware imperfections that remain detectable across different signal widths and observable bandwidths.

The key intuition is that hardware imperfections are intrinsic to the physical components of the device and are thus independent of the signal bandwidth. Thus, when a signal with a bandwidth larger than training bandwidth W is received, the example embodiment divides it into smaller segments, each matching the W for which the model was trained. Similarly, when faced with a signal that spans a larger observable bandwidth \tilde{B}>B, the example embodiment divides the larger bandwidth into smaller, partially overlapping segments, each of size B. Each segment is processed individually by the DNN and the outputs are combined to form a final output that covers the entire bandwidth \tilde{B}. After processing, the predictions from these individual segments—whether divided by signal width or observable bandwidth—are aggregated to form a cohesive understanding of the entire wider signal \tilde{W} or bandwidth \tilde{B}. This aggregation step ensures that even when the signal spans a larger width or bandwidth, the model's predictions are consistent and accurate, effectively identifying the unique radio fingerprint embedded within the signal. This capability highlights the scalability and portability of our approach, making it highly versatile for deployment across various RF environments where both signal widths and observable bandwidths can vary significantly.

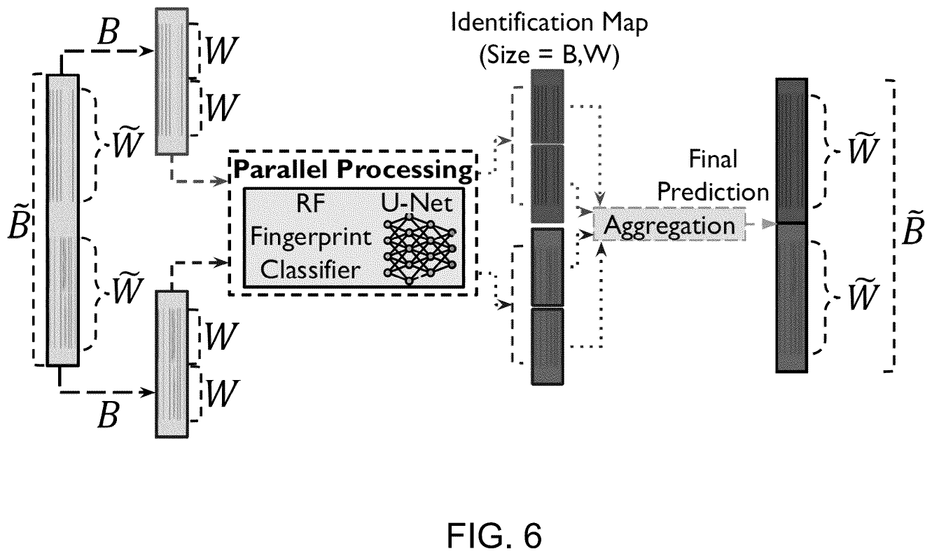

FIG. 6 shows the adaptive pipeline that efficiently processes signals exceeding the standard training bandwidth. Specifically, for an input that has larger signal bandwidth W or observable bandwidth B, the pipeline first divides it into multiple overlapping chunks and each segment will have an individual score output by the signal segmentation model. After that, the aggregation block is used to average the overlapped output of multiple chunks while keeping the same score for non-overlapping output. The input signal covering a larger bandwidth \tilde{B} or wider channel width \tilde{W} is divided into overlapping segments of size B or W, processed by the U-Net model. The outputs are then aggregated to produce the final prediction across the full signal or bandwidth. This method ensures that the system of the example embodiment can accurately process and analyze signals across a wide range of bandwidths and channel widths, maintaining high precision in radio fingerprinting.

Loss Functions and Optimization. Several loss functions were investigated and are presented the results below. The loss functions are part of local-level and region-level metrics. Local-level loss measures accuracy at each frequency bin within the raw I/Q data, capturing fine-grained variations essential for distinguishing signal characteristics. Region-level loss, on the other hand, considers larger segments within the data, promoting consistency across continuous sections and enhancing detection of broader patterns, such as distinct signal regions or transmission boundaries. We summarize them as follows.

Dice Loss (DiL). DiL is a region-based metric used to assess the similarity between predicted labels and ground truth, which is derived from the Dice coefficient, a widely used measure of similarity. It is defined as:

$$DiL = 1 - \frac{2 \times {\sum }_{i - 1}^{n} {y}_{i} + {\hat{y}}_{i}}{{\sum }_{i - 1}^{n} {y}_{i} + {\sum }_{i - 1}^{n} {\hat{y}}_{i} + ϵ} , \qquad ( 8 )$$

where yᵢ and ŷᵢ are the ground truth and predicted values, respectively, and ϵ is a small constant to avoid division by zero. DiL focuses on maximizing the overlap between the predicted and ground truth masks, making it suitable for tasks where precise segmentation is critical.

Intersection over Union Loss (IoUL). The IoUL is another region-based loss function that measures the overlap between the predicted and ground truth. It is defined as:

$$IoUL = 1 - \frac{{\sum }_{i - 1}^{n} {y}_{i} + {\hat{y}}_{i}}{{\sum }_{i - 1}^{n} {y}_{i} + {\sum }_{i - 1}^{n} {\hat{y}}_{i} - {\sum }_{i - 1}^{n} {y}_{i} \times {\hat{y}}_{i} + ϵ} . \qquad ( 9 )$$

This loss is particularly useful in cases where there is significant class imbalance, as it penalizes both false positives and false negatives.

Cross-Entropy Loss (CEL). The CEL is a loss function for classification tasks and is defined as

$$CEL = - {\sum }_{i = 1}^{n} {y}_{i} log ( {\hat{y}}_{i} ) \qquad ( 10 )$$

This loss provides a local-level accuracy of semantic segmentation which is used as a baseline in our experiments and is combined with other loss functions to improve the model performance.

Binary Cross-Entropy Loss (BCEL). BCE is widely used for binary classification tasks and is similar to CEL but adapted for binary output. It is defined as:

$$BCE = - {\sum }_{i = 1}^{n} {y}_{i} log ( {\hat{y}}_{i} ) + ( 1 - {y}_{i} ) log ( 1 - {\hat{y}}_{i} ) . \qquad ( 11 )$$

BCE is effective for multi-label segmentation tasks where each frequency bin can belong to more than one class, making it particularly relevant for radio fingerprinting scenarios with overlapping signals.

Focal Loss (FL). FL is designed to address the issue of class imbalance by down-weighting the contribution of easy examples during training and focusing on hard-to-classify examples. It is defined as:

$$FL = - {α ( 1 - {\hat{y}}_{i} )}^{γ} log ( {\hat{y}}_{i} ) \qquad ( 12 )$$

where α is a balancing factor and γ is the focusing parameter. FL is particularly effective in improving the performance of the DNN on under-represented classes.

Combined Loss (CL). To leverage the strengths of different loss functions, a CL function is implemented that integrates both local-level and region-level losses, defined as:

$$CL = β \times CE + L ( 1 - β ) \times IoUL , \qquad ( 13 )$$

where β is a weighting factor that balances the contribution of each component. As such, we can optimize both fine-grained accuracy and overall region consistency.

Adversarial Detection. In a spectrum sharing system, detecting malicious users is as important as identifying legitimate devices. Accordingly, an anomaly detection approach is used that leverages the uncertainty in the DNN output. During training, only legitimate signals are used, which results in confident predictions for authorized devices. Conversely, a malicious signal not seen during training will be less confident, thus enabling the example embodiment to detect adversaries by evaluating the randomness of the spectrum map.

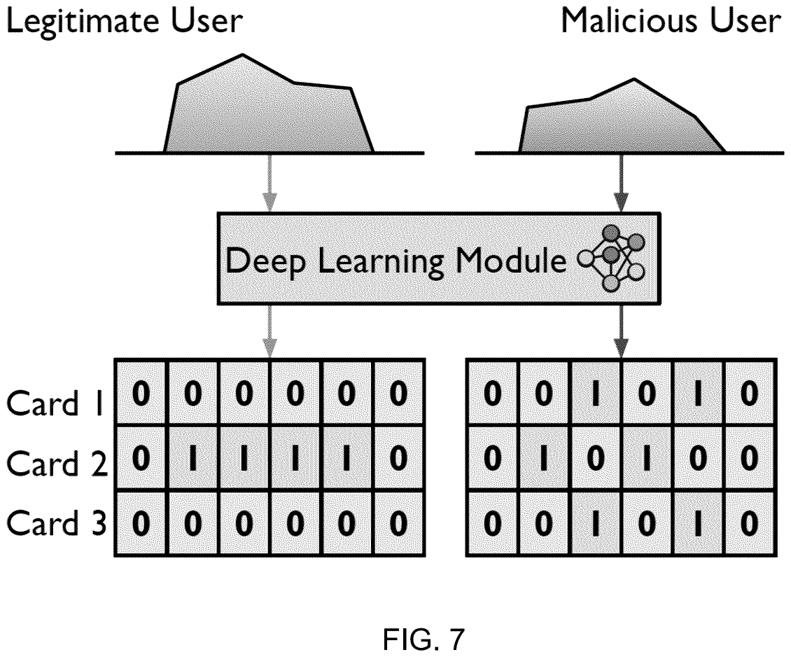

Total variation is applied to quantify adversarial activity, which evaluates the consistency of the DNN output across the frequency domain. Higher total variation indicates a higher likelihood of a malicious signal. For a 1D vector x, the total variation is defined as:

$$T V ( x ) = {\sum }_{i = 0}^{N - 1} \vert {x}_{i + 1} - {x}_{i} \vert , \qquad ( 14 )$$

where xᵢ is the i-th element in vector x while N denotes the dimension of the input. While total variation is first introduced for denoising, the element-wise distance |xᵢ₊₁−xᵢ| evaluates the consistency in DL module output in this case, making it a good metric to detect the malicious user who constantly has a noisier output than legitimate user. For example, the total variation of the legitimate user output in FIG. 7 is two (2) while the malicious user output has a total variation of 12. By increasing the resolution in frequency domain (e.g., the example embodiment uses 4096 as the input and output size), the difference of total variation between legitimate and malicious users will increase significantly.

By comparing the TV values for legitimate and malicious signals, we set a detection threshold λₘ:

$$TV ( x ) {{≷}^{{H}_{1}}}_{{H}_{0}} {λ}_{m} , \qquad ( 15 )$$

where H₀ denotes the hypothesis that signal x is not an adversary and H₁ denotes the alternative hypothesis that x is considered as adversary.

### Experimental Setup for Example Embodiment (M2RF)

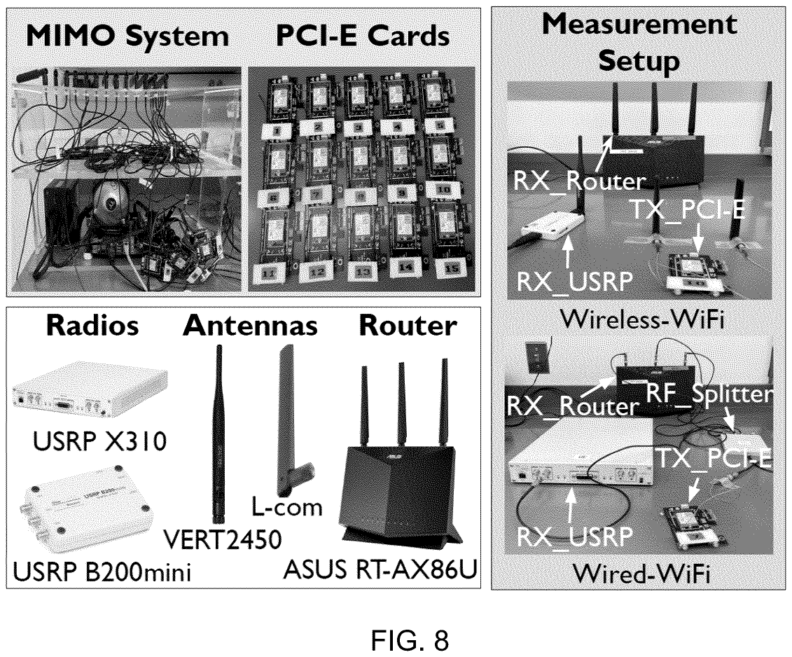

The data collection setup captures radio fingerprints under two distinct scenarios-wireless and wired-using sophisticated hardware to ensure accuracy and reliability. As shown in FIG. 8, the configuration of the example embodiment includes a Multiple-Input Multiple-Output (MIMO) system for the simultaneous transmission of 15 PCI-E wireless local area network (LAN) cards, all identical in model and version (IEEE 802.11ac/ax). This choice of identical devices creates a challenging test scenario, generating highly correlated signals to rigorously test the example embodiment's ability to distinguish between identical transmitters. The ASUS® RTAX86U router is used as the primary receiver, and I/Q data is captured via a universal software radio peripheral (USRP) X310 and USRP B200mini, each equipped with VERT2450 and L-com antennas.

Two testbeds were created to evaluate radio fingerprinting performance under both wireless and wired data collection methods. The wireless setup, where radio transmissions from the PCI-E cards are captured by the USRP radios through antennas, simulates a realistic, uncontrolled environment, typical of actual deployments. This setup provides insight into radio fingerprint behavior in dynamic conditions affected by interference, multi-path effects, and environmental variability. Conversely, the wired setup provides a controlled baseline with a higher signal-to-noise ratio (SNR) of around 20-25 dB, compared to 15-20 dB in the wireless setup. This comparison highlights the robustness of our radio fingerprinting approach across varying SNR levels and operating conditions.

Data were collected over three days within a laboratory setting to capture a wide range of signal conditions. This approach accounted for environmental factors like temperature fluctuations and electromagnetic interference. Data was collected across two specific frequency bands—5.5 GHz (channel 100) and 5.6 GHz (channel 120)—within a 50 MHz observable bandwidth, with each Wi-Fi card transmission occupying a 20 MHz bandwidth. To prevent signal overlap and ensure distinct RF fingerprints, each PCIE card's transmission was captured separately, achieving the precision necessary to differentiate between devices with nearly identical hardware profiles.

Hardware Characteristics. The training of the DNNs was performed on 4 NVIDIA® A100 80 GB PCIe graphics processing units (GPUs). The system is equipped with 512 GB of RAM, running on Rocky Linux, and is powered by two Intel Xeon Silver 4410Y processors with a total of 48 cores and a maximum clock speed of 3.9 GHZ. This configuration ensures exceptional performance for large-scale DNNs tasks. After training, the DNNs were run on the Jetson Orin Nano module, powered by a 6-core ARM® Cortex-A78AE 64-bit central processing unit (CPU). The system is equipped with 8 GB of 128-bit LPDDR5 memory and a 1024-core NVIDIA® Ampere architecture GPU with 32 Tensor Cores, capable of delivering up to 40 TOPS (Tera Operations Per Second).

Experimental Dataset and Training. Experiments were conducted in both wireless and wired modes, primarily focusing on signals within a 50 MHz bandwidth. The primary dataset includes signals from 15 authorized devices, comprised 1.25 million samples, with 80% allocated for training and 20% for testing across three distinct scenarios: non-overlapping, overlapping, and partially observed signals. For training, we used the Adam optimizer with a StepLR learning rate scheduler, starting at 0.001 and reducing by a factor of 0.1 every 30 epochs. The DNN was trained for 100 epochs with a batch size of 1024, with early stopping applied after 30 epochs of no improvement to prevent overfitting. To rigorously test the example embodiment resilience against potential attacks, we prepared additional testing datasets for specific attack scenarios of white box attack and black box attack.

White-Box Attack. Data was collected from unauthorized devices identical in hardware to the authorized devices but excluded these samples from training. This test set was used exclusively to evaluate the example embodiment ability to detect malicious users who share the same hardware characteristics as authorized devices, relying solely on the unique radio fingerprints derived from subtle hardware imperfections.

Black-Box Attack. We collected data from devices having different hardware characteristics and signal bandwidths than those used during training. As such, we collected data with devices using Bluetooth® Low Energy (BLE) with bandwidth 1 MHz, Long Term Evolution (LTE) with bandwidth 10 MHz, Zigbee with bandwidth 2 MHz, as well as with additional Wi-Fi devices in the 2.4 GHz band.

### Performance Evaluation

Evaluation of Loss Functions. We discuss a comparative analysis of various loss functions applied to the radio fingerprinting task of non-overlapping signals. Table 1 shows that the CL function achieves the highest performance across all metrics, with an Intersection over Union (IoU) of 77.37%. This highlights the effectiveness of combining local-level and region-level loss functions.

TABLE 1
Performance Metrics for Different Loss Functions
in Scenario 1 with an Input Size of 1024.

| Loss Function | IoU (%) | Precision (%) | Recall (%) | F1-Score (%) |
|---|---|---|---|---|
| BCEL | 77.08 | 86.48 | 86.50 | 86.49 |
| CEL | 77.04 | 86.44 | 86.43 | 86.43 |
| CL | 77.37 | 86.66 | 86.65 | 86.65 |
| DiL | 60.34 | 83.13 | 69.75 | 75.85 |
| FL | 76.07 | 85.79 | 85.74 | 85.76 |
| IoUL | 59.84 | 83.11 | 68.81 | 75.29 |

DiL and IoUL show significantly lower IoU values (around 60%). While FL performed better than DiL and IoUL, it does not perform as well as BCEL, CEL and especially CL. As such, we chose CL for our next experiments.

### Performance Across Input Sizes and Scenarios

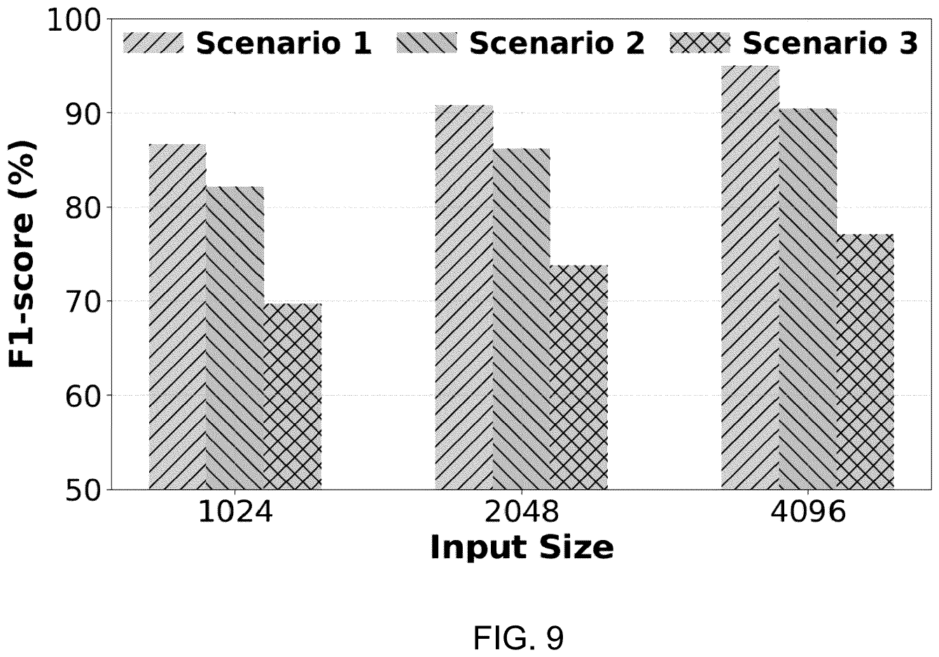

Wireless Mode. We started with wireless data and compared F1-score for different input sizes (1024, 2048, 4096) between the three scenarios defined in FIG. 4 to analyze how well M2RF performs. As depicted in FIG. 9, the F1-scores for all scenarios significantly improve as we increase the input size. For scenario 1, the F1-score approaches as high as 86.65% with 1024 input size but increases nearly perfectly to a value of 94.99% to even an input size of 4096, showing that the trained model without overlap predict very well between each signal class. In scenario 2, a similar trend observed, where F1-scores increases from 82.11% at 1024 to reach around value of 90.45% at 4096. The significant improvement is in scenario 3, where the F1-score improves from 69.71% at 1024 to 77.06% at 4096, with this difference demonstrating the M2RF robustness against overlapping signals. On the other hand, larger input sizes imply higher processing latency.

Similarly, the IoU metric is a good indicator for segmentation accuracy. As expected, the IoU reaches 90.54% for an input size of 4096 in scenario 1, while scenario 2 slightly drops to 82.75%, due to the complexity introduced with random signal placements. In scenario 3 IoU decreases to 63.39% as signals now overlap and become harder to localize within the spectrum correctly. However, these results highlight the adaptability and robustness of the M2RF in varying RF environments.

TABLE 4
Metrics for Different Input Sizes and Scenarios in Wireless Mode

| Input | | Precision | Recall | F1-Score | IoU |
|---|---|---|---|---|---|
| Size | Scenario | (%) | (%) | (%) | (%) |
| 1024 | 1 | 86.66 | 86.65 | 86.65 | 77.37 |
| | 2 | 82.21 | 82.06 | 82.11 | 70.68 |
| | 3 | 76.28 | 64.35 | 69.71 | 54.99 |
| 2048 | 1 | 90.86 | 90.83 | 90.84 | 83.50 |
| | 2 | 86.24 | 86.10 | 86.16 | 76.12 |
| | 3 | 80.87 | 68.09 | 73.81 | 59.45 |
| 4096 | 1 | 95.02 | 94.97 | 94.99 | 90.54 |
| | 2 | 90.52 | 90.39 | 90.45 | 82.75 |
| | 3 | 84.56 | 70.97 | 77.06 | 63.39 |

Detailed Metrics for Each Modality. Table 4 shows an analysis of the performance of M2RF in detail over various input sizes (1024, 2048 and 4096) with respect to wireless mode for three different scenarios. We quantify the aspect of device-specific characterization from each input size, especially in a wireless scenario when signals are likely to get received and disturbed due to environmental interferences. The constant high performance of the 4096-input size shows its appropriateness as a benchmark. Table 5 presents the corresponding results in wired mode, where the improved signal quality and reduced interference further enhance performance, establishing an “ideal” scenario for comparison.

Input Size 1024. When an input has a size of 1024, the metrics show that while the M2RF captures features at device level, it does not perform well at the lower IoU values as in scenario 3, where it only achieves an IoU of 54.99%. The small input size limits the signal information that can be used for model processing. This hinders the handling of more complicated signal scenarios with heavy interference or overlaps. Precision, recall and F1-scores also drop across scenarios (see for instance the 86.65% F1-score in scenario 1 versus a much lower F1-score of 69.71% in scenario 3). The aforementioned limitations, however, imply that 1024 is poor for robust radio fingerprinting within dynamic wireless environments.

Input Size 2048. Increasing the input size to 2048 gives significant improvements on all metrics. In scenario 1, the F1-score is raised to 90.84%, and IoU increases to 83.50%, which demonstrates that it can tell apart device characteristics more easily with a bigger data sample through M2RF. On the other hand, in scenario 3 where signals frequently overlap, we observe that the IoU and F1-score are still low at 59.45% and 73.81%, respectively. Though we set the M2RF to this input size of 2048 to allow capturing finer intricacies within the signal, it is clear from our results that larger values will be needed in order to obtain strong accuracy under complicated wireless conditions.

Input Size 4096. The M2RF obtains its best performance in terms of all the metrics having as input 4096. Scenario 1 achieves a precision of 95.02% (F1-score of 94.99%, IoU of 90.54%), which suggests that the M2RF can leverage the broader input size to identify device-specific hardware imperfections in the RF signals. In scenario 3, where it is logic to believe the overlapping signals will challenge the model, we still achieve an F1-score of 77.06% and an IoU of 63.39%, which is a far better performance than using any smaller input size. This means that 4096 is better for accounting full radio fingerprinting details, even under wireless mode scenarios in which signal interference occurs where the transmissions can be more accurately localized within the spectrum.

Based on these results, we set 4096 as our input size baseline which strikes a balance between accuracy and generalizability for radio fingerprinting problems in wireless and wired mode.

Benchmark Results in Wired Mode. As Table 5 shows, these metrics also indicate that a wired mode with an input size of 4096 performs better. In scenario 1, the precision, recall and F1-score were all greater than 99%, with an IoU value of 99.12%, suggesting almost perfect identification accuracy. In scenario 2, the F1-score and IoU are both high (95.95% and 92.29%, respectively), which shows that even in optimal conditions the example embodiment accommodates a small portion of signal belonging to structure within its part of the observable spectrum. When things get difficult in scenario 3 with overlapping signals, the example embodiment achieves an F1-score of 81.60% and IoU of 69.66%, also higher than the wireless counterpart. The effectiveness of the radio fingerprinting under better channel condition with enough SNR margin and less interference is reflected in this result, suggesting that 4096 input size is preferable for high accuracy device authentication.

TABLE 5
Metrics for 4096 Input Size and Scenarios in Wired Mode

| Scenario | Precision (%) | Recall (%) | F1-Score (%) | IoU (%) |
|---|---|---|---|---|
| 1 | 99.56 | 99.55 | 99.56 | 99.12 |
| 2 | 96.01 | 95.90 | 95.95 | 92.29 |
| 3 | 89.41 | 75.24 | 81.60 | 69.66 |

In general, the comparison of wireless and wired modes justifies the choice of an input size of 4096 for radio fingerprinting purposes. Although performance in the wireless mode depends on signal complexity, the results for the wired mode provide a consistent baseline, validating that input size is capable of capturing intricate device-specific imperfections even under difficult conditions.

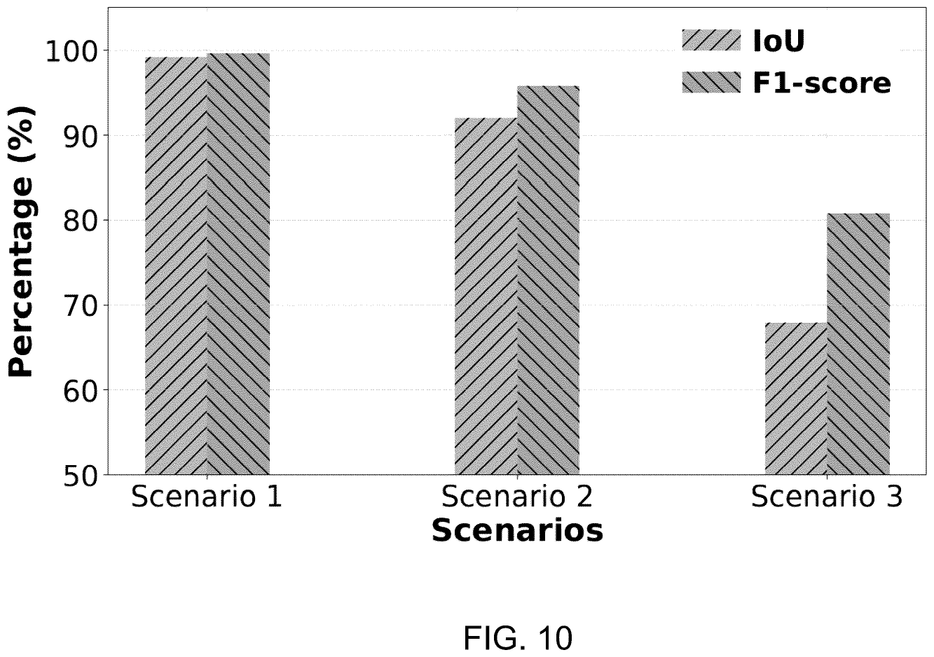

Wired Mode. We further evaluate the robustness of M2RF in a wired setup, using the same input size of 4096 to ensure consistency with the wireless mode. FIG. 10 shows that the wired setup achieved notably higher scores, which is expected given the absence of interference.

In scenario 1 where the signals do not overlap, M2RF obtained a IoU of 99.12% and an F1-score of 99.56%, implying almost no misclassification. This shows the ability of M2RF to identify independent, non-nested signal sources. In a moderately-challenging conditions (scenario 2) with partially observed signals, we obtain an IoU of 92.29% and F1-score of 95.95%, demonstrating the resilience of M2RF. The wired setup resulted in 69.66% IoU and 81.6% F1-score, even under scenario 3-the worst-case conditions with both fully and partially overlapping signals.

Confusion Matrices Analysis. Deeper insights into the M2RF's classification accuracy were gained by analyzing the confusion matrices for each scenario, using wireless data with an input size of 4096. These matrices offer a detailed breakdown of true and false identifications across all 15 devices.

Additional Results for Wired Mode. This section provides an overview of the performance for three scenarios of wired mode under input size 4096. This wired connection means that the signals are much cleaner and less susceptible to interference, enabling the example embodiment to attain higher accuracy. The confusion matrix for each of the scenarios demonstrate how well the system performs under various signals conditions as seen below.

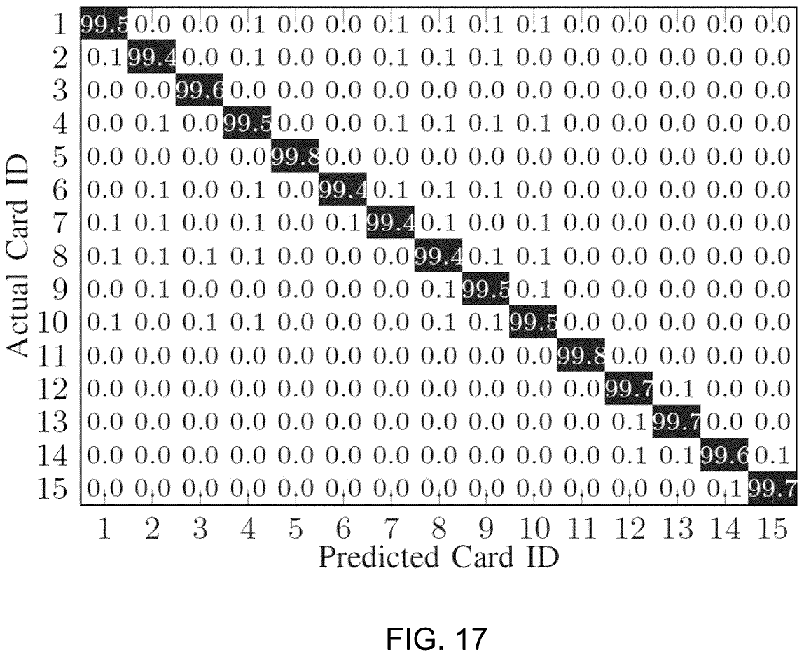

Scenario 1: Non-overlapping Signals. The first wired scenario shows excellent performance also seen in the confusion matrix in FIG. 17 as all card IDs provide accuracy values above 99%. Card 1 gives us an accurate of 99.5%, card 3 that is 99.6% and card 5 gets to this number at 99.8%. Since the signals are non-overlapped in this use case, it is easy for the model to identify each device separately. This scenario underscores the effectiveness of radio fingerprinting under ideal conditions where each device's unique signal characteristics are isolated, thereby minimizing potential misclassification. The high performance in this case exemplifies how hardware imperfections can be effectively leveraged for device identification in a controlled setting.

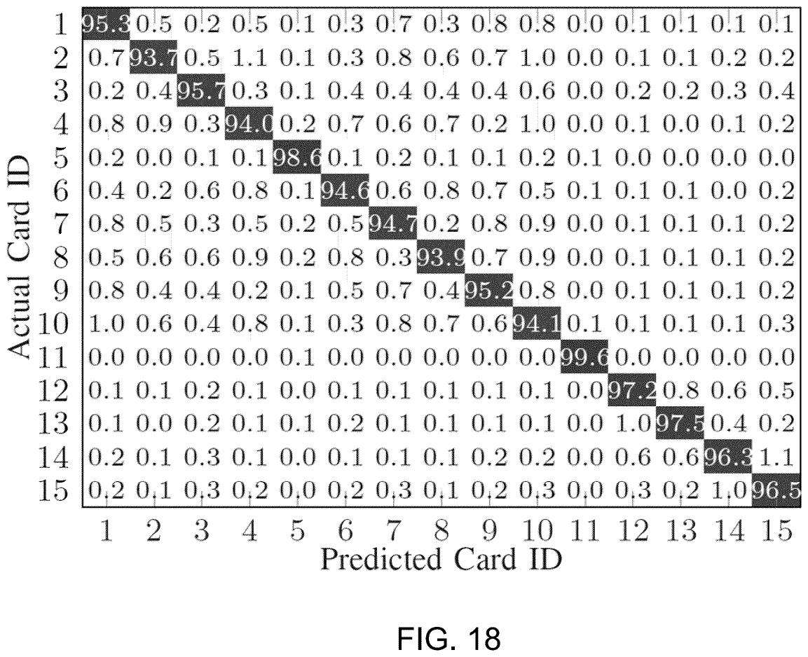

Scenario 2: Partial Observation with Random Frequency Centers. Scenario 2, illustrated in FIG. 18 does not degrade accuracy greatly but will degrade bit by bit more than what was the case in scenario 1 due to more complex signals. Note that in example cards 1 and 3 we can see the accuracies at 95.3% and 95.7%, but card 5 has a higher accuracy of 98.6%. Partial signals and random frequency centers make it more challenging to separate device-specific features from the data. Nevertheless, the M2RF performs reliably well, being able to struggle with more complicated signal patterns but still uniquely separating devices due to hardware imperfections inherent in each. These results suggest the robustness of M2RF to small changes in signal characteristics, a necessary trait for dynamic RF environments where signal properties experience moderate fluctuations.

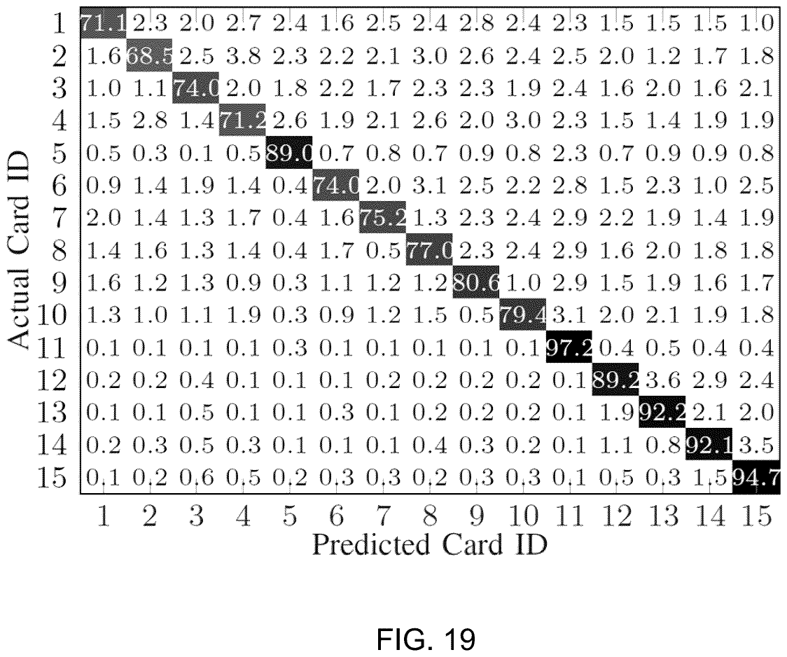

Scenario 3: Partial/Full Signals Overlapping. FIG. 19 shows the confusion matrix generated for scenario 3, which again highlights how challenging it is when signals are fully or partially overlapping; accuracy is significantly lower in comparison to all scenarios. For instance, cards 1 and 3 get lower accuracies of 71.1% and 74% respectively and also good performances are attained on cards 9 until 15 with above accuracy of 80%. Because several signals occupy the same or adjacent frequency bins, it becomes challenging for the M2RF to discriminate between them and they are more often misclassified. Nevertheless, the wired mode's improved signal quality helps mitigate some of the interference, allowing the M2RF to maintain reasonable performance despite the challenging conditions. In this scenario, the heavy overlap among signals shows the limitations of radio fingerprinting (while also proving that M2RF is still able to extract discriminative features even in challenging RF scenarios).

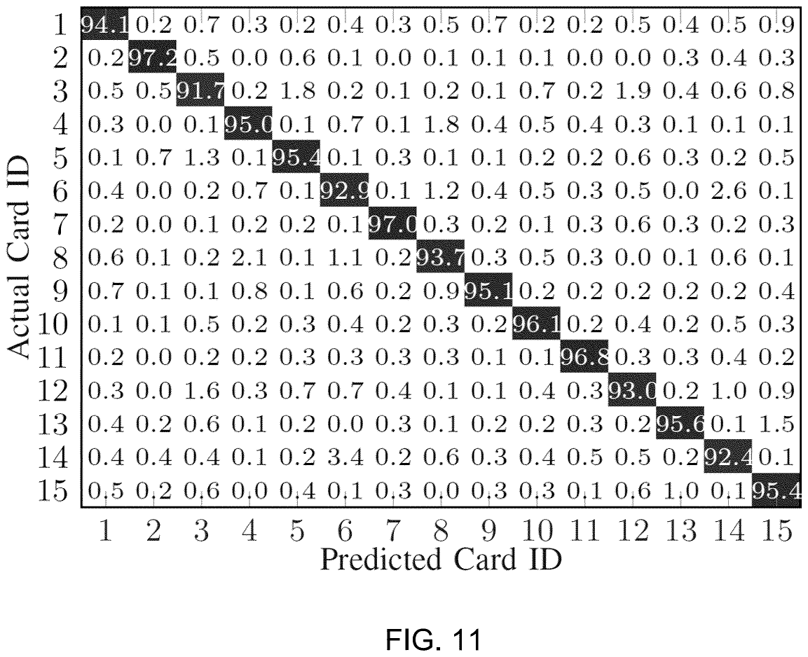

In scenario 1 shown in FIG. 11, the confusion matrix of non-overlapping signals provides that M2RF achieves a high classification accuracy, and most devices get an accuracy greater than 90%. For instance, card 1 achieves 94.1%, and card 2 reaches 97.2%, reflecting the system's effectiveness in distinguishing devices when signals are isolated and clearly separated.

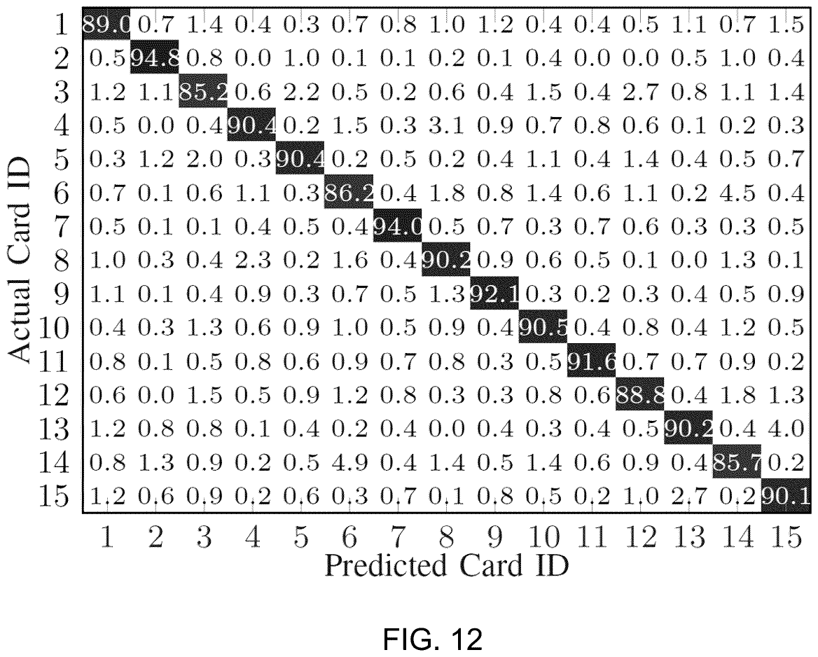

Scenario 2, shown in FIG. 12, introduces an increased level of complexity with randomly placed signals within the bandwidth. This setup represents a more realistic real-world scenario, where signals can be partially or fully present into the observable bandwidth, generating signal glitches on duration and shifting. Although M2RF achieves high performance for multiple devices (e.g., card 2 at 94.8%) there is a small drop in accuracy for others, such as card 3 (85.2%). The variation in this performance illustrates the M2RF's robustness to non-ideal conditions where the signals are not perfectly isolated, thus making the classification problem harder and M2RF learning to generalize across unpredictable scenarios.

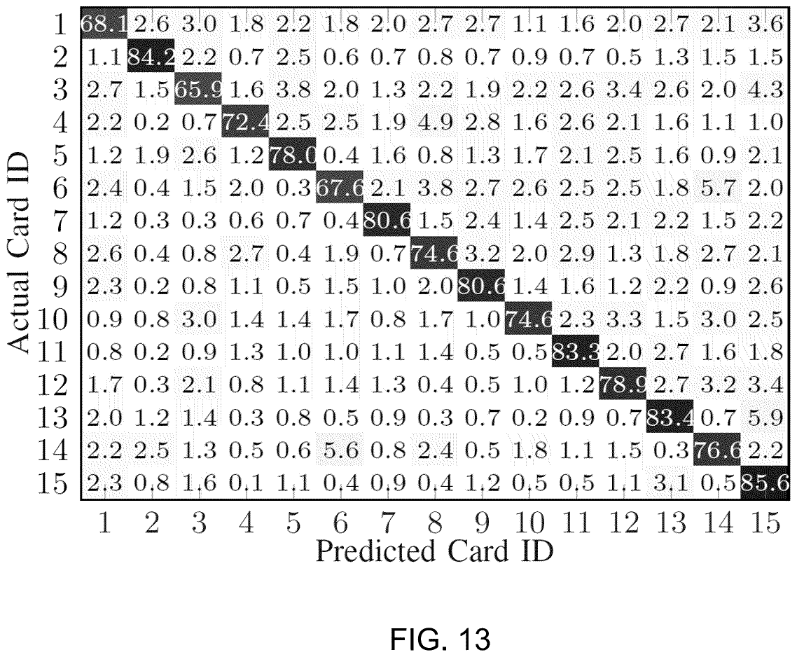

Scenario 3 is shown in FIG. 13 which is full or partial overlapping of signals. At this point, accuracy rates further decrease, where card 1 gets only 68.1% and card 3 gets only 65.9%. Such a decrease is intuitive as if the signals overlap in the same frequency range, finding the characteristics of signal would be difficult. These obstacles notwithstanding, the M2RF still performs well in accurately classifying most devices and shows it could operate in congested RF environments where overlaps are frequently observed.

The distinguishing of devices in scenario 3 by the M2RF also suggests its ability to test against jamming attack and even detect it. In those cases, we may actually have intentional disruptions within the spectrum represented by overlapping signals. The M2RF's strong localization of these overlapping signals would enable the development of a target countermeasure where the M2RF can detect and suppress jamming in real-time with minimal impact to other neighboring communications. This capability adds a critical dimension to the M2RF's utility in dynamic, interference-prone environments, where prompt and accurate signal identification is essential for maintaining security and integrity.

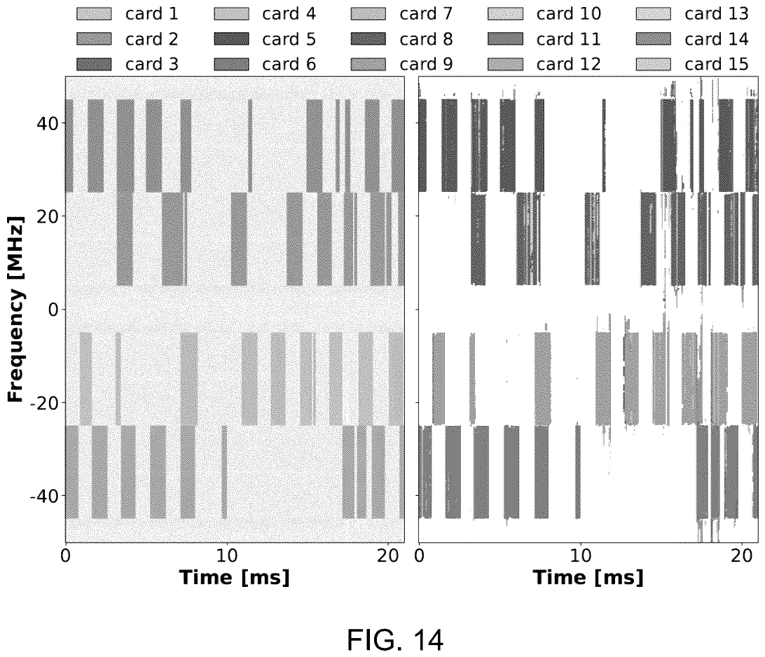

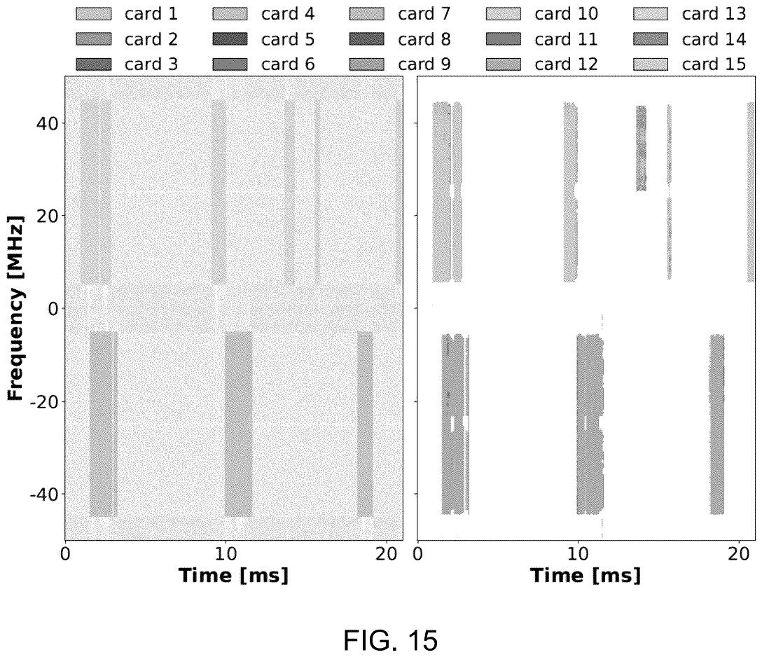

Scalability and Generalization. The following section describes the scalability and generalizability of M2RF across different bandwidths and channel widths. The DNN was initially trained with a 50 MHz bandwidth and 20 MHz-wide signals and then tested under varying bandwidths to assess whether the hardware imperfections it leverages remain consistent. These evaluations provide insights into M2RF's adaptability to changing spectral conditions. Key cases are illustrated in FIGS. 14 and 15, using data collected on a different day with unseen signal conditions, which typically vary due to environmental factors. In the first test, the system of the example embodiment was evaluated with a 100 MHz bandwidth containing four devices, each occupying 20 MHz.

As shown in FIG. 14, the example embodiment successfully distinguishes between these signals, achieving an F1-score of 90.22% and an IoU of 82.32%. Although performance shows a slight reduction from the 50 MHz baseline, this decrease can be attributed to the increased spectral complexity scalability, maintaining effective detection and localization of multiple signals within the broader bandwidth without requiring retraining. In a second test, M2RF was evaluated with two signals that were 40 MHz wide in a 100 MHz bandwidth. M2RF achieved F1-score of 87% and an IoU of 77.29%. The broader signal, along with its associated noise, added complexity to this configuration. Even though the accuracy falls a little, M2RF is still able to correctly identify and localize every signal, as shown in FIG. 15. The above result illustrates the robustness of M2RF to changes in channel width as well as signal structure. Most importantly, the system performed a correct classification without retraining, making our M2RF approach even more robust.

This establishes that, although we see some degradation in performance at higher bandwidth demand cases, the fundamental approach remains resilient. The signal-recognition capabilities of the M2RF, including its scalability and robustness to changing channel width and signal overlap, rely on hardware-induced imperfections that vary consistently across devices. These frequency-specific distortions because of hardware imperfection persist across different bandwidths allowing for reliable classification and consequently localization of the signal, yielding a robust fingerprinting approach that can work well with both diverse and dynamic RF environments. Such scalability and flexibility are essential for practical applications where spectral conditions will change, and the system has to function properly across a wide range of bandwidths and interference levels.

System Defense under Malicious Activity. We rigorously evaluated M2RF's defense capabilities against multiple threat models, including both white-box and black-box attacks within Wi-Fi networks, as well as interference from other wireless technologies in congested spectrum environments.

In the white-box attack scenario, an intelligent, high-level threat is assumed as the attacker has full knowledge of the authentication method and ML model used, as well as access to identical hardware as the legitimate devices. However, the black-box attack setting represents a more realistic scenario in which the attacker uses potentially different hardware versions unknown to the system at training time. To evaluate the robustness of M2RF in crowded spectrum environments, black-box attacks were also performed with respect to signals from other non-Wi-Fi technologies like BLE, LTE and Zigbee. This multi-technology challenge tests the example embodiment's capability to detect unauthorized transmissions amidst diverse signal types, reflecting real-world conditions in densely populated RF environments.

TABLE 2
System Performance Under Attacks in Wi-Fi Networks

| | | P | R | F1 | MR | FAR |
|---|---|---|---|---|---|---|
| Attack Type | User | (%) | (%) | (%) | (%) | (%) |
| Black-Box | Authorized | 98.29 | 87.66 | 92.67 | 12.34 | 1.52 |
| | Malicious | 88.90 | 98.48 | 93.44 | 1.52 | 12.34 |
| White-Box | Authorized | 95.71 | 87.51 | 91.43 | 12.49 | 3.91 |
| | Malicious | 88.51 | 96.09 | 92.14 | 3.91 | 12.49 |

Overall Accuracy: 92.44%

Approximately 100,000 samples were used, evenly split between authorized and malicious transmissions, to evaluate system performance for each attack type. As shown in Table 2, M2RF consistently performed well in distinguishing authorized from malicious signals using a TV-based threshold of TV=8. In black-box attack scenario, the system reached an F1-score of 92.67% for authorized devices and 93.44% for malicious devices, with a mean Miss Rate (MR) of 2.72% across both attack types, demonstrating reliable detection of unauthorized signals even when attackers use different hardware. For white-box attacks, where the attacker's hardware matches that of the authorized devices, the example embodiment maintained a high F1-score of 91.43% for authorized devices and 92.14% for malicious devices, showing robustness against highly sophisticated adversaries, without requiring retraining on specific attack data.

TABLE 3
System Performance Under Attacks Using Other Technologies

| User | P (%) | R (%) | F1 (%) | MR (%) | FAR (%) |
|---|---|---|---|---|---|
| Authorized | 78.23 | 87.47 | 82.59 | 12.53 | 24.45 |
| Malicious | 85.72 | 75.55 | 80.31 | 24.45 | 12.53 |

Overall Accuracy: 81.52%

Table 3 highlights the example embodiment's ability to differentiate authorized Wi-Fi signals from non-Wi-Fi signals in a multi-technology setting, achieving an overall accuracy of 81.52%. This multi-technology evaluation confirms M2RF's adaptability in congested spectrum environments, such as the 2.4 GHz band, effectively distinguishing authorized Wi-Fi devices from other signals without requiring retraining on these technologies. By leveraging unique radio fingerprints, M2RF maintains high performance across various RF conditions, proving its capability for secure spectrum management and defense against unauthorized access in high-traffic, multi-technology scenarios.

Energy-Latency Trade-off for Different Input Sizes on an Edge Device. In the experiments on energy-latency trade-offs, we measured the performance of different input sizes—1024, 2048, and 4096—on both GPU and CPU through Jetson Orin Nano device. The primary metrics were mean inference time (MIT) and mean energy consumption (MEC), which are crucial for evaluating real-time M2RF efficiency. Despite the CPU having lower mean power consumption (MPC) per millisecond (ms), the significantly longer MIT leads to much higher total energy consumption compared to the GPU. For example, at an input size of 4096, the inference time on the GPU was 20.87 ms compared to 391.62 ms on the CPU, demonstrating the GPU's substantial speed advantage for time-critical applications.

MEC was calculated using the formula:

$$MEC ( mJ ) = MIT ( ms ) \times MPC ( mW ) . \qquad ( 16 )$$

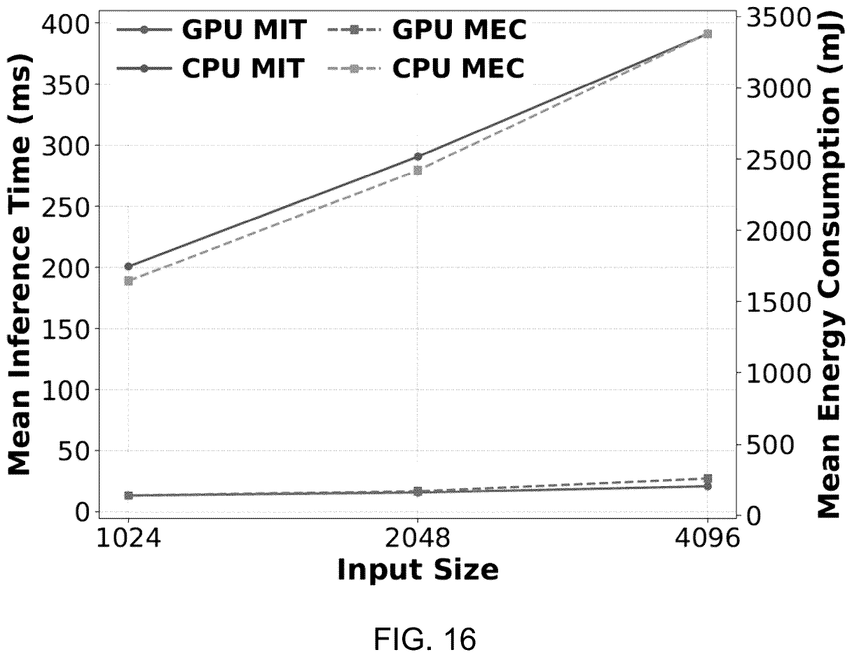

This formula highlights that, while the CPU may consume less power (8.63 milliwatts (mW) for input size 4096), the much longer inference time leads to a significantly higher energy consumption (3381.50 millijoules (mJ)), compared to the GPU's energy consumption of 257.95 mJ for the same input size. Thus, the GPU's slightly higher power draw (12.36 mW) is more than offset by its superior processing speed, making it far more energy-efficient in total energy use. FIG. 16 further illustrates this trade-off, showing how both MEC and MIT increase with input size, but at a much steeper rate for the CPU than for the GPU.

An input size of 4096 turned out to be the optimal solution, providing a suitable trade-off between feature representation and computational efficiency. Increasing input sizes allows the model to extract detailed features from RF signals, which is important to help differentiate malicious from adversarial devices. Its energy footprint enables easy deployment under resource constraints, such as those commonly encountered in IoT networks or on edge devices, while still handling larger input sizes—making the GPU a suitable choice. In short, the relative fast and energy efficiency of our design enables a solid performance for realtime radio fingerprinting tasks and security applications.

Impact of Dataset Size and Diversity. The scalability of radio fingerprinting depends heavily on the size and diversity of the training data. Although the dataset of the example embodiment achieved high accuracy, it may not fully capture the variety of device characteristics encountered in real-world applications. Other embodiments may expand the dataset to cover a wider range of devices, communication protocols, and environmental conditions to strengthen the model's ability to generalize effectively. Some embodiments may utilize the collection of over-the-air (OTA) data from diverse sources, which improves the model's adaptability to real-world conditions and further enhance its robustness across different scenarios.

Computational Constraints in Edge Devices. The approach of the described embodiments is designed as a centralized framework, with authentication managed by a server equipped for high computational loads. The system was tested on an edge device to evaluate performance under limited resources. The system may be further optimized for operation in a distributed deployment, where nodes independently manage authentication or face constraints due to low-power edge devices. Other optimizations may be performed through model quantization, pruning or edge-cloud cooperation to maintain flexibility on central and distributed settings.

Adversarial Attacks. Although system of the example embodiment effectively detects white-box and black-box attacks, it may still be susceptible to advanced adversarial techniques. An attacker could exploit vulnerabilities through perturbations to penetrate the system. Other embodiments may aim to strengthen the system's defenses against such attacks without requiring retraining on specific adversarial examples and to develop real-time detection mechanisms adapting to evolved attacks patterns.

Manual Tuning and Real-World Deployment. Some components of the example embodiment, particularly threshold for detecting malicious users, required manual tuning during experiments. This approach may be less effective in dynamic environments. Some embodiments may utilize an adaptive thresholding mechanism, based on real-time feedback, to enhance detection without manual intervention, making the system more practical for real-world use.

While example embodiments have been particularly shown and described, it will be understood by those skilled in the art that various changes in form and details may be made therein without departing from the scope of the embodiments encompassed by the appended claims.

What is claimed is:

1. A method of authenticating a received authorized signal, comprising:
converting signals received within a spectrum of bandwidth B into a frequency domain representation of bandwidth B;
segmenting the frequency domain representation of bandwidth B into spectrum segments each of training bandwidth W;
for each spectrum segment,
applying the spectrum segment to a neural network; and
receiving, from the neural network, a radio frequency identification map comprising two or more classification vectors;
determining a total variation across the two or more classification vectors; and
identifying the received authorized signal as authenticated when the total variation is less than a threshold value.

2. The method of claim 1, further comprising training the neural network using a training dataset of wideband training samples.

3. The method of claim 2, further comprising generating each of the wideband training samples by stitching together two or more stored signals.

4. The method of claim 3, further comprising generating each of the two or more stored signals by (i) generating, in a controlled environment, a radio signal having a center frequency and a bandwidth, (ii) segmenting the radio signal into smaller portions using a windowing function, (iii) filtering each of the smaller portions using a band-pass filter, (iv) converting each of the smaller portions into the frequency domain, (v) pruning frequencies outside of a frequency band of interest, and (vi) storing each of the segmented, filtered, pruned, frequency domain signal representations in a signal repository.

5. The method of claim 2, further comprising estimating a noise floor across the training dataset of wideband training samples by recording minimum values of smoothed signal power in the frequency domain.

6. The method of claim 2, further comprising generating each of the wideband training samples as (i) non-overlapping in-band signals, (ii) one or more in-band signals and one or more partially out-of-band signals, and/or (iii) overlapping in-band signals.

7. The method of claim 1, wherein the neural network has a U-Net architecture.

8. The method of claim 7, wherein the U-Net architecture neural network has a non-local block incorporated into a last layer of the neural network.

9. The method of claim 1, further comprising aggregating predictions from individual spectrum segments to form the radio frequency identification map.

10. The method of claim 1, wherein receiving signals further comprises receiving in-phase and quadrature (I/Q) data from a radio receiver.

11. A system for authenticating a received authorized signal, comprising:
a radio frequency receiver that
(i) receives signals within a spectrum of bandwidth B;
(ii) converts the signals into a frequency domain of bandwidth B; and
(iii) segments the frequency domain of bandwidth B into spectrum segments each of training bandwidth W;
a processor; and
a memory with computer code instructions stored thereon, the memory operatively coupled to the processor such that, when executed by the processor, the computer code instructions cause the system to:
implement a neural network that produces, for each spectrum segment, a radio frequency identification map that comprises two or more classification vectors;
determine a total variation across the two or more classification vectors; and
identify the received authorized signal as authenticated when the total variation is less than a threshold value.

12. The system of claim 11, wherein the neural network is trained using a training dataset of wideband training samples.

13. The system of claim 12, wherein each of the wideband training samples is generated by stitching together two or more stored signals.

14. The system of claim 13, wherein the computer code instructions further cause the system to (i) generate, in a controlled environment, a radio signal having a center frequency and a bandwidth, (ii) segment the radio signal into smaller portions using a windowing function, (iii) filter each of the smaller portions using a band-pass filter, (iv) convert each of the smaller portions into the frequency domain, (v) prune frequencies outside of a frequency band of interest, and (vi) store each of the segmented, filtered, pruned, frequency domain signal representations in a repository.

15. The system of claim 11, wherein the neural network has a U-Net architecture.

16. The system of claim 11, wherein the U-Net architecture neural network has a non-local block incorporated into a last layer of the neural network.

17. The system of claim 11, wherein predictions from individual spectrum segments are aggregated to form the radio frequency identification map.

18. A method of authenticating a received authorized signal, comprising:
receiving radio frequency signals;
converting the radio frequency signals into a frequency domain representation and segmenting the frequency domain representation into spectrum segments;
for each spectrum segment,
applying the spectrum segment to a neural network; and
receiving, from the neural network, a radio frequency identification map comprising two or more classification vectors;
determining a total variation across the two or more classification vectors; and
identifying the received authorized signal as authenticated when the total variation is less than a threshold value.

19. The method of claim 1, further comprising training the neural network using a training dataset of wideband training samples.

20. The method of claim 2, further comprising generating each of the wideband training samples by stitching together two or more stored signals.
